(19) United States
(12) Patent Application Publication
(10) Pub. No.: US 2005/0246210 A1
(43) Pub. Date: Nov. 3, 2005

(54) Pet boarding method and system

(75) Inventor: Margaret Thompson, Phoenix, AZ (US)

Correspondence Address: DONALD J. LENKSZUS, PO BOX 3064, CAREFREE, AZ, 85377-3064, US

(73) Assignee: SLEEPOVER ROVER, Phoenix, AZ (US)

(21) Appl. No.: 11/106,323

(22) Filed: Apr. 14, 2005

Related U.S. Application Data
(60) Provisional application No. 60/566,331, filed on Apr. 28, 2004.

(51) Int. Cl. G06F 17/60

(52) U.S. Cl. 705/5

(57) ABSTRACT

A system and method for matching pet owners with hosts for boarding pets is provided. Databases comprising host information and pet owner information are provided and matching of pet owners and hosts based upon predetermined criteria stored in the databases.

This application claims the benefit of copending Provisional Application for Patent Ser. No. 60/566,331 filed on Apr. 28, 2004

### FIELD OF THE INVENTION

The present invention pertains to a method and system for providing boarding of animals, in general, and to a method and system for matching pet owners with hosts for boarding of pets, in particular.

### BACKGROUND OF THE INVENTION

Many pet owners refuse to subject their pets to kennel care when they need to be away from home. In the past, alternatives to kennels were very limited.

One alternative to kennels is to have individuals access homes to care for pets while the owners were gone. However this is unacceptable to many pet owners because the dogs or pets would be alone in the house for most of the day.

So called “doggie-day care” facilities are another alternative, but are undesirable to many pet owners because the dogs were traumatized by other animals and subjected to communicable diseases and parasites.

A further alternative is to request family or friends to board the pet. However, such requests when done frequently are an undesirable imposition on family and friends.

Accordingly, it is highly desirable to provide for the boarding or “hosting” of pets with pre-screened individuals and families.

### SUMMARY OF THE INVENTION

I discovered many individuals who were delighted to temporarily care for our dogs. I interviewed and visited these individuals and then tested the waters by dropping off our dogs for one day only. The second time I delivered my dogs and watched them bound up the front walk to their host families, I determined that never again would I leave my pets in any other environment. I also discovered that the host families' lives were truly enriched by the companionship of the visiting pet. Our hosts became almost extended family members—trusted and appreciated animal lovers who opened their arms and homes to someone else's beloved canine companion. For the first time I enjoyed guilt-free vacations and worry-free business trips!

A method for providing for boarding of pets in accordance with the invention includes providing a computer database for storing first sets of information. Each first set of information identifying a pet host, geographic information and other host information. The method includes providing a computer database for storing second sets of information. Each second set of information for each pet owner desiring to have a pet host includes geographic information, pet specific information and other pet owner information. The method further includes matching each pet owner with hosts based upon the pet owner second set of information and the hosts' first sets of information.

The method further includes verifying each first set of information; and verifying each second set of information.

In accordance with another aspect of the invention, the method includes providing centralized billing of pet owners for boarding; and providing for centralized payment to hosts for boarding.

A system for providing for boarding of pets comprises a computer database having stored therein first sets of information. Each said first set of information identifies a pet host, geographic information and other host information. The system includes a computer database having stored therein second sets of information. Each second set of information identifies a pet owner desiring to have a pet host. The second information includes geographic information, pet specific information and other pet owner information. The system includes a system manager operable with the first and said second databases to match each pet owner with hosts based upon the pet owner second set of information and the hosts' first sets of information.

A system in accordance with the invention may include at least one connection between the system manager and a network.

### BRIEF DESCRIPTION OF THE DRAWING

The invention will be better understood from a reading of the following detained description of an embodiment of the invention in conjunction with the drawing figures in which like reference elements refer to like element, and in which:

FIG. 1 is a flow diagram of the method of the invention and operation of a system in accordance with the invention;

FIG. 2 is a diagram of a system in accordance with the invention;

FIG. 3 is a block diagram of a portion of the system of FIG.2;

FIG. 4 illustrates a first database entry; and

FIG. 5 illustrates a second database entry.

### DETAILED DESCRIPTION

The method and system of the invention, identified as “Sleepover Rover™”, provides dog owners with a truly superior alternative to boarding their animal companions. By interviewing and identifying quality host families within the community, Sleepover Rover™ establishes a network that is searchable to identify care providers for pets.

A network of local care-providers is established. Each care-provider is willing and able to provide a loving, safe, nurturing home environment for dogs whose families are on vacation, on business, or otherwise unavailable to care for their pet. Each potential care-provider or “host” is identified and interviewed before being selected to be a care-provider. Each pet owner requesting a care-provider is referred to hosts within their neighborhood. The pet owner interviews the hosts and selects those that are, in the determination of the pet owner, appropriate for the pet. The pet owner is provided assurance that in the event that a host is, for any reason, unable to continue to board a pet, that an alternate host is available. The pet owner or “pet parents” deliver and pick up their pet from the host at the host' s home, thereby assuring themselves of the quality of the environment in which the pet will be boarded and the nature and personality of the care-giver.

Should the host have an emergency while caring for a pet, the host contacts Sleepover Rover™. A Sleepover Rover™ agent utilizes the Sleepover Rover™ system to identify a substitute host that has been pre-approved by the pet owner, and immediately arranges transport of the pet from the original host and placement of the pet with the substitute host.

In the event a pet that is being boarded needs need medical care, the host contacts Sleepover Rover™ . A Sleepover Rover™ agent utilizes the Sleepover Rover™ system to identify a pre-approved veterinary care facility identified by the pet owner and arranges for transporting the pet to the pre-determined veterinary care facility. Sleepover Rover™ provides for care on short notice, and takes into account special needs and preferences of pets and their owners.

It is an object of the invention to promote the physical and emotional well-being of the pet and the peace-of-mind of the pet owner.

In accordance with our invention, every decision is subjected to the criterion of what is best for the pet. By maintaining this focus, a network of animal lovers is established that assures no pet need ever again spend time isolated in a cage wondering if they have been abandoned by their pet parent. A safe, loving, attentive temporary foster home environment is provided for pets.

A network of animal loving hosts is established and maintained whose primary objective is to provide for the well-being of canine companions.

In accordance with the invention a team of host families that are carefully screened, supported and encouraged by our representatives are provided. Each host is an independent contractor. As independent contractors, they enjoy flexibility and autonomy, yet they are assured of prompt payment, emergency support, professional advice, and a steady stream of clients pre-screened to meet the requirements they have set.

Further in accordance with the invention, a client base of pet parents or owners who rely on Sleepover Rover™ to connect them with loving and proficient caregivers who live in a pet-safe environment within their neighborhoods. Our pet parents leave with peace of mind knowing that their beloved companion is a welcomed guest in the home of a trusted animal lover who truly cares for the welfare and happiness of the pet. I envision a world in which animal companions can live cage-free!

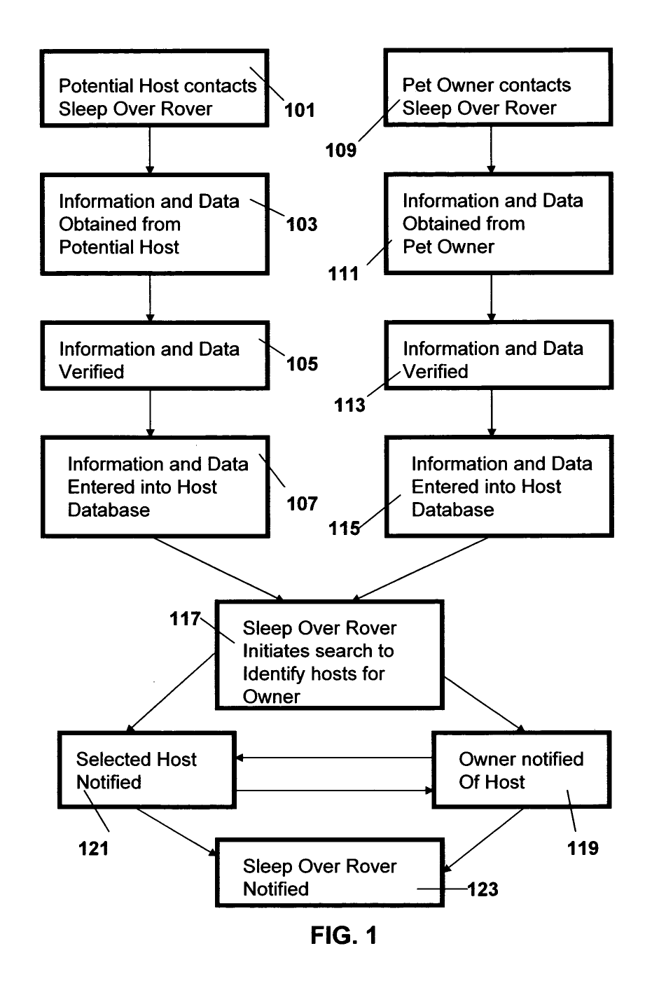

Turning now to the drawing figures, an embodiment of the invention is described. FIG. 1 illustrates the method of the invention and the operation of a system in accordance with the invention.

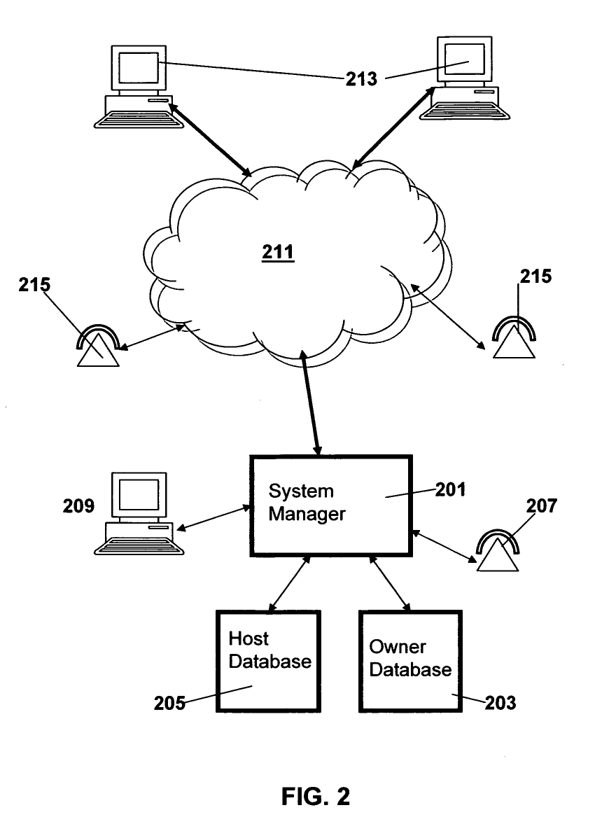

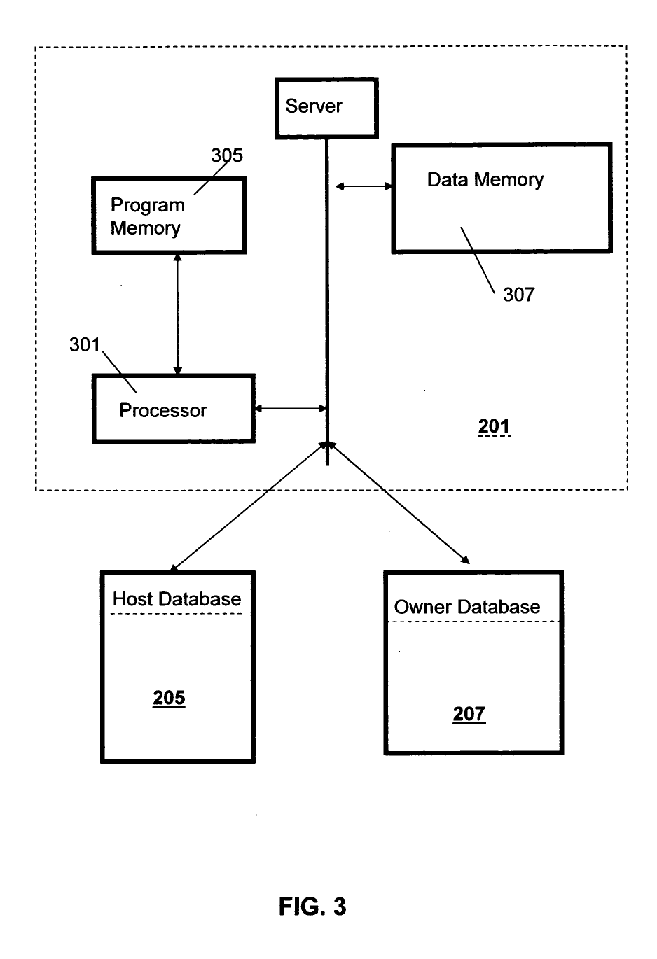

At step 101, a potential host for pets contacts or is contacted by SleepOver Rover™. At step 103, information and data is obtained from the potential host which is verified by SleepOver Rover at step 105. The verification process may include an on site visit to the potential host to determine that the surroundings in which a pet would be maintained meet quality standards of SleepOver Rover™, and an in person interview with the potential host. Based upon the results of the verification, the host's information is entered into a host database 205 as shown in FIGS. 2 and 3.

Similarly, a pet owner desiring to utilize SleepOver Rover™ contacts SleepOver Rover™ at step 109. Information and data is obtained from the Pet Owner at step 111, and is verified at step 113. In addition, if payment is to be by credit care, verification is made of the credit card that the pet owner intends to use. After the information and data has been verified, at step 115 it is entered into the pet owner database 207.

At step 117, SleepOver Rover™ initiates a search of the host database to identify hosts that meet criteria for the Pet Owner and its pets. One of the key factors in the identification is geographic proximity to the Pet Owner. In the embodiment of the invention, postal zip codes and major crossroads are utilized to establish proximity. After completing the search, one or more hosts are identified. A determination is made that the hose is available on the dates needed before contact/pres-screening is to occur. After the identification has been made and availability determined, the identified host will contact the pet owner to provide pre-screening and approval. The pet owner then lets SleepOver Rover™ know if the host or hosts is approved. In the event the first referred host is unacceptable, another host is identified and referred.

At the time a pet owner wishes to use the services of SleepOver Rover™, SleepOver Rover™ contacts the pre-approved host at step 121, and verifies the availability of the host for the time or times that the pet owner wishes to have the pet boarded. Once the host is identified, SleepOver Rove™ contacts the pet owner at step 121. The pet owner and host then communicate to finalize any arrangements if necessary. At the time the pet owner commits to utilizing the host, SleepOver Rover™ is notified at step 123. In addition, when the boarding ends, SleepOver Rover™ is again notified.

The pet owner typically prepays for the services on-line via credit card or via a mailed check. Advantageously, SleepOver Rover™ pays the host for the boarding directly when the boarding period is ended. SleepOver Rover™ charges the pet owners credit card for the boarding amount which includes a service fee. As part of the verification process, both the hosts and the pet owners who utilize SleepOver Rover™ sign an agreement which obligates payment to SleepOver Rover™ in the event that either party ceases to utilize SleepOver Rover™, but continues to board with a SleepOver Rover™ identified host SleepOver Rover™.

The system of the invention is shown in FIGS. 2 and 3. A system manager 201 is utilized to process all data and information. System manager 201 stores host and pet owner information and data in host database 205 and pet owner database 207, respectively. It will be appreciated by those skilled in the art that the databases 205, 207 may be configured in many possible ways and the showing of separate functional databases is not intended to limit the invention in any way. System manager 201 may be accessed and controlled by an input output interface which is shown for illustrative purposes as a computer terminal 209.

System manager 201 may be accessed via a network which may be a network 211 of a type currently utilized, or which may be devised in the future including public switched telephone network, a wireless network, or the world wide web of computers known as the Internet. By providing network access, system manager 201 may be accessed from geographically remote locations. Access may be via Internet devices 213 or the like and telephones 215 which may be wired or wireless. With this arrangement a central database may be maintained that permits pet owners who travel with pets, but want or need to board the pets while traveling, to access SleepOver Rover™ to identify hosts at their destination or intermediate travel points.

In accordance with another aspect of the invention, SleepOver Rover™ maintains a central database, and in one embodiment of the invention includes a network of agents each of whom act as a local SleepOver Rover™ contact point for purposes of identification and verification of hosts and pet owners.

System manager 201 in the illustrative embodiment includes a processor 301, program memory 305 and data memory 307. System manager 201 further includes one or more servers for access to network 211. One or more of the servers may be a database managing server that automatically provides correlation of data between the host and pet owner database. Data memory 307 is multipurpose and one of the purposes is to include secure account and billing information for SleepOver Rover™.

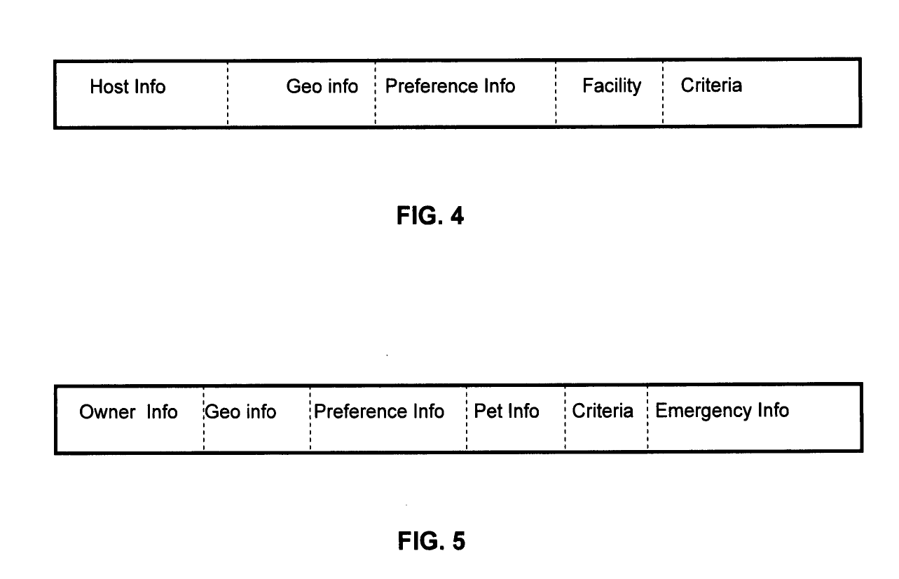

FIGS. 4 and 5 illustrate, respectively, data entries for each host and each pet owner. Each data entry includes a plurality of data fields from which the various matching criteria may be searched to match hosts and pet owners. Additional data fields may be included for each host and each pet owner.

The invention has been described in terms of an illustrative embodiment. It will be appreciated by those skilled in the art that various changes and modifications may be made to the embodiment shown and described without departing from the spirit or scope of the invention. It is not intended that the invention be limited by the illustrative embodiment.

1. A method for providing for boarding of pets comprising:
providing a computer database for storing first sets of information, each of said first set of information identifying a pet host, geographic information and other host information;
providing a computer database for storing second sets of information, each of said second set of information for each pet owner desiring to have a pet host, said data including geographic information, pet specific information and other pet owner information; and
matching each pet owner with hosts based upon said pet owner second set of information and said first sets of information.

2. A method in accordance with claim 1, comprising:
verifying each said first set of information; and
verifying each said second set of information.

3. A method in accordance with claim 1, comprising:
providing centralized billing of pet owners for boarding; and
providing for centralized payment to hosts for boarding.

4. A method in accordance with claim 1, wherein:
said matching step is performed automatically.

5. A method in accordance with claim 1, comprising:
obtaining from a prospective pet host said pet hose geographic location information and said other host information utilized in determining the suitability of said host for boarding specific pets.

6. A method in accordance with claim 5, comprising:
obtaining from a pet owner said pet owner geographic information, said pet specific information and said other pet owner information.

7. A method in accordance with claim 6, comprising:
obtaining a request from a first pet owner for a pet host for dates specific.

8. A method in accordance with claim 7, comprising:
utilizing said database comprising said first sets of information to identify one or more pet hosts for said first pet owner based upon said request and said first sets of information.

9. A method in accordance with claim 9, comprising:
determining the availability of said one or more pet hosts for said dates specific; and
selecting one of said one or more hosts that is available for said dates specific.

10. A method in accordance with claim 9, comprising:
providing information to said selected one host and said first pet owner so that said selected one host and said first pet owner can communicate with each other.

11. A method in accordance with claim 10, comprising:
obtaining prepayment from said first pet owner.

12. A method in accordance with claim 1, comprising:
providing a network of agents each of whom acts as a local contact point for purposes of identification and verification of hosts and pet owners.

13. A method in accordance with claim 1, comprising:
providing access to said first and said second sets of information via a network.

14. A method in accordance with claim 1, comprising:
providing a system manager for managing said first and said second sets of information.

15. A method in accordance with claim 14, comprising:
providing access to said system manager via the world wide web.

16. A method in accordance with claim 14, comprising:
utilizing said system manager to match said pet owners and said hosts.

17. A system for providing for boarding of pets comprising:
a computer database having stored therein first sets of information, each of said first set of information identifying a pet host, geographic information and other host information;
a computer database having stored therein second sets of information, each of said second set of information for each pet owner desiring to have a pet host, said data including geographic information, pet specific information and other pet owner information; and
a system manager operable with said first and said second databases used to match each pet owner with hosts based upon said pet owner second set of information and said first sets of information.

18. A system in accordance with claim 17, comprising:
at least one connection between said system manager and a network.
